(19) United States
(12) Patent Application Publication
(10) Pub. No.: US 2009/0316853 A1
(43) Pub. Date: Dec. 24, 2009

(54) BRILLIANT X-RAYS FOR CASTING INSPECTION RADIOGRAPHY AND COMPUTED TOMOGRAPHY

(76) Inventors: Claudio G. Parazzoli, Normandy Park, WA (US); Robert B. Greegor, Auburn, WA (US); Richard H. Bossi, Renton, WA (US)

Correspondence Address: DUKE W. YEE, YEE & ASSOCIATES, P.C., P.O. BOX 802333, DALLAS, TX, 75380, US

(21) Appl. No.: 12/145,214

(22) Filed: Jun. 24, 2008

(51) Int. Cl. H05G 1/60

(52) U.S. Cl. 378/4

(57) ABSTRACT

A brilliant x-ray inspection device comprises a brilliant x-ray source and a detector. The brilliant x-ray source generates mono-energetic, narrow beam x-rays at an identified energy. A portion of an object is positioned within a path of the mono-energetic, narrow beam x-rays. The detector generates brilliant x-ray data describing the object in three dimensions based on results of the x-ray scan of the object. The brilliant x-ray inspection device then generates a set of brilliant x-ray images of the portion of the object. The features of the object are identified based on the set of brilliant x-ray images.

### BACKGROUND INFORMATION

1. Field:

The present disclosure relates generally to investment casting and in particular to nondestructive casting inspection. Still more particularly, the present disclosure relates to a method and apparatus utilizing mono-energetic, directional x-rays to increase the sensitivity of nondestructive inspection of cast structures.

2. Background:

Investment casting is one of the oldest known metal-forming techniques. During investment casting, a mold is produced in the pattern of a structure that is to be cast. When the mold is completed, molten metal is poured into the mold. After the metal cools, the mold is removed and the cast structure is then finished.

Investment casting is a potentially low cost process used to fabricate net shape unitized parts, such as aerospace structures from titanium. A net shape unitized structure is a single unit structure that has initial production features that are very close to the final features of the structure when production is complete. Investment casting may be used to create various types of parts, such as, without limitation, complete aircraft door frames, engine mount and frame, turbine blades, and precision parts.

Conventional processes in current production of aerospace parts without the use of casting processes involves hog-out and finish machining of titanium plate or forgings, followed by e-beam welding and weld land machining for assembly. This may be a long, difficult, and expensive process. In contrast, manufacturing the same part using casting can result in substantial recurring labor and material cost savings. For example, part fabrication using casting may reduce costs by sixty-eight percent due to reduction of machining and materials usage. Casting may also result in one-hundred percent assembly savings by eliminating joints through part unitization, thus avoiding welding and assembly costs.

However, casting structures may have sub-surface inclusions, fine porosity, or other anomalies in the casting structure that may make the structure unsuitable for its intended use. Therefore, nondestructive inspection of the casting structure may be needed. Current nondestructive inspection techniques may include conventional polychromatic x-ray radiography, neutron radiography, and ultrasonic techniques. However, these nondestructive inspection technologies have only limited sensitivity for evaluating thick titanium structures. For example, current x-ray radiographic sensitivity in inspection is limited by the combination of the penetrating power of the x-ray and the scatter field intensity of the scattered radiation. Thus, it would be advantageous to have a method and apparatus that overcomes the problems of the limited sensitivity of casting x-ray inspection.

### SUMMARY

An embodiment of the present disclosure provides a brilliant x-ray inspection device that comprises a brilliant x-ray source and a detector. The brilliant x-ray source generates mono-energetic, narrow beam x-rays at an identified energy. A portion of an object is positioned within a path of the mono-energetic, narrow beam x-rays. The detector generates brilliant x-ray data. The brilliant x-ray inspection device then generates a set of brilliant x-ray images over a region of the object. The features of the object are identified based on the set of brilliant x-ray images.

In another advantageous embodiment, a method of inspecting casting structures is provided. An energy and attenuation coefficient for a brilliant x-ray inspection of an object is identified. The mono-energetic, narrow beam x-rays are generated at the identified energy. A portion of the object is positioned within a path of the mono-energetic, narrow beam x-rays. A set of brilliant x-ray images of the portion of the object is generated. Brilliant x-ray data describing the object in three dimensions is generated based on results of the x-ray scan of the object. The features of the object are identified based on the set of brilliant x-ray images.

Yet another embodiment provides an apparatus that comprises a brilliant x-ray source; a brilliant x-ray detector; a bus system; a communications system coupled to the bus system; a memory connected to the bus system, wherein the memory includes computer usable program code; and a processing unit coupled to the bus system. The processing unit executes the computer usable program code to receive a result of a brilliant x-ray scan of an object, wherein a portion of the object is scanned by mono-energetic, narrow beam x-rays at an identified energy; generate brilliant x-ray data describing the object in three dimensions based on results of the x-ray scan of the object; and generate a set of brilliant x-ray images of the portion of the object, by the brilliant x-ray inspection device, wherein features of the object are identified based on the set of brilliant x-ray images.

The utilization of brilliant x-rays for casting inspection radiography and computed tomography increases the sensitivity of x-ray inspections of cast structures. The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is a diagram illustrating an aircraft manufacturing and service method in accordance with an advantageous embodiment;

FIG. 2 is a diagram illustrating an aircraft in which an advantageous embodiment may be implemented;

FIG. 3 is a diagram of a cast structure having sub-surface anomalies in accordance with an advantageous embodiment;

FIG. 4 is a diagram illustrating an attenuation equation for deriving the sensitivity in x-ray radiography in accordance with an advantageous embodiment;

FIG. 5 is a diagram illustrating a brilliant x-ray inspection digital radiography device in accordance with an advantageous embodiment;

FIG. 6 is a diagram illustrating a brilliant x-ray inspection computed tomography device in accordance with an advantageous embodiment;

FIG. 7 is a diagram illustrating a data processing system in accordance with an advantageous embodiment; and

FIG. 8 is a flowchart illustrating a process for inspecting a casting structure using a brilliant x-ray inspection device in accordance with an advantageous embodiment.

### DETAILED DESCRIPTION

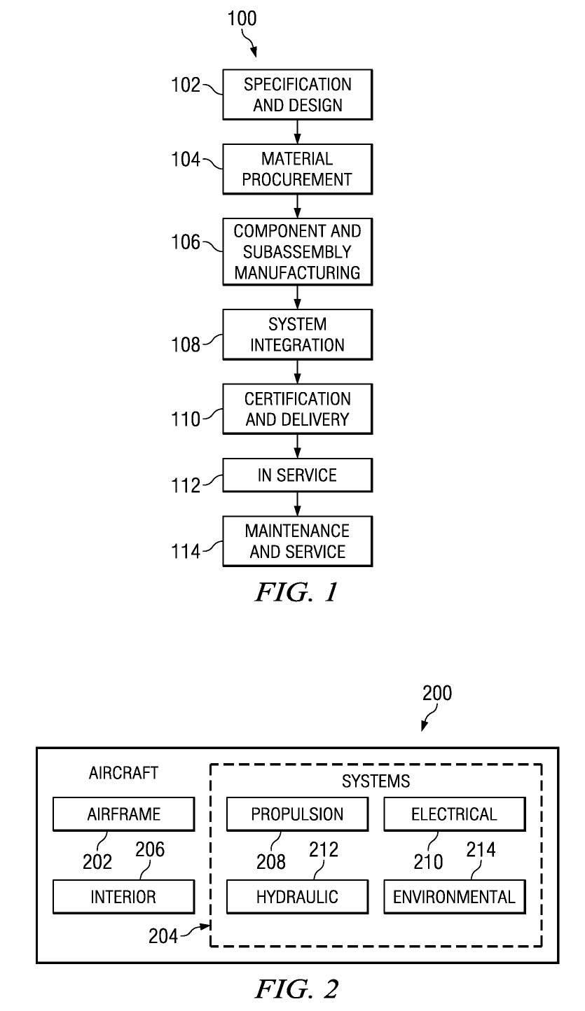

Referring more particularly to the drawings, embodiments of the disclosure may be described in the context of the aircraft manufacturing and service method 100 as shown in FIG. 1 and aircraft 200 as shown in FIG. 2. Turning first to FIG. 1, a diagram illustrating an aircraft manufacturing and service method is depicted in accordance with an advantageous embodiment. During pre-production, exemplary aircraft manufacturing and service method 100 may include specification and design 102 of aircraft 200 in FIG. 2 and material procurement 104. During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

With reference now to FIG. 2, a diagram of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, and environmental system 214. Any number of other systems may be included. Although an aerospace example is shown, different advantageous embodiments may be applied to other industries, such as the automotive industry.

Apparatus and methods embodied herein may be employed during any one or more of the stages of aircraft manufacturing and service method 100 in FIG. 1. For example, components or subassemblies produced in component and subassembly manufacturing 106 in FIG. 1 may be fabricated or manufactured in a manner similar to components or subassemblies produced while aircraft 200 is in service 112 in FIG. 1. Also, one or more apparatus embodiments, method embodiments, or a combination thereof may be utilized during production stages, such as component and subassembly manufacturing 106 and system integration 108 in FIG. 1, for example, without limitation, by substantially expediting the assembly of or reducing the cost of aircraft 200. Similarly, one or more of apparatus embodiments, method embodiments, or a combination thereof may be utilized while aircraft 200 is in service 112 or during maintenance and service 114 in FIG. 1.

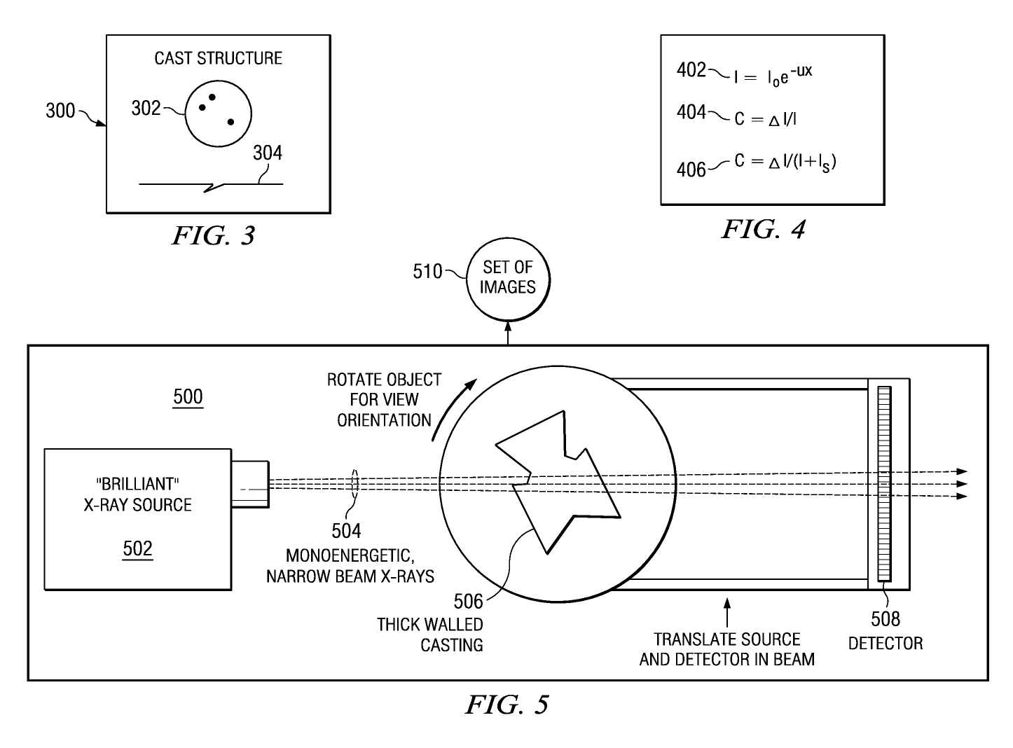

FIG. 3 is a diagram of a cast structure having sub-surface anomalies in accordance with an advantageous embodiment. Cast structure 300 is an object that is produced by a casting process, such as, without limitation, titanium investment casting. Cast structure 300 may be titanium, titanium alloy, aluminum, aluminum alloy, copper, iron, steel, any other metal, any other metal alloy, or any other substance. Cast structure 300 may be for example, and without limitation, a titanium aerospace part used in an aircraft, such as aircraft 200 in FIG. 2.

Fine porosity 302, inclusions, or other features may sometimes occur below the surface of casting structure during the casting process. For example, the mold used during casting is typically coated with scale. Some of the scale material may find its way into the casting structure. The scale and any other substances that become absorbed into the casting structure during the casting process may form inclusions.

In this example, cast structure 300 has fine porosity 302 and crack 304 below the surface of the structure. Fine porosity 302 may be fine holes or hollow areas within the structure. Fine porosity 302, crack 304, inclusions, or other sub-surface anomalies may render cast structure 300 unsuitable for its intended use and function. Therefore, it may be important to detect these anomalies using non-destructive evaluation techniques, such as x-ray inspection.

The advantageous embodiments recognize that the savings of investment casting for large structural titanium castings may be prohibitive due to the requirements for sensitive inspection of casting structures and the cost of inspections. In addition, casting structures of a certain thickness are not used in aerospace applications because inspection cannot be guaranteed to sufficient accuracy using currently available nondestructive inspection techniques. As used herein, a casting structure is any structure, unitized part, or other object that is produced using a casting process, such as, without limitation, investment casting, sand casting, or any other type of casting process.

Turning to FIG. 4, a diagram illustrating an attenuation equation for deriving the sensitivity in x-ray radiography in accordance with an advantageous embodiment. The transmitted intensity “I” of the x-rays is identified in accordance with equation 402 as follows:

I=Iₒe^{-ux}.

In equation 402, “Iₒ” is the initial intensity of the x-rays' energy, “u” is the attenuation coefficient, and “x” is the thickness of the casting structure that is being inspected. The Compton effect, also referred to as Compton scattering, is the decrease in energy and corresponding increase in wavelength of an x-ray photon when it interacts with matter. Thus, when conventional x-rays interact with a casting structure, Compton scattering leads to a decrease in the x-rays' energy and a decrease in the contrast of the x-ray image produced by the inspection process. Contrast refers to the ability to distinguish feature details in an image. In equation 404, contrast in the image “C” is calculated as follows:

C=ΔI/I.

The change in intensity “C” is due to the change in thickness of the casting structure or a change in the attenuation coefficient “u”. In other words, a thicker casting structure may cause greater attenuation and scattering than a thinner casting structure.

In conventional radiography, the contrast “C” is affected by the presence of scattered radiation “Iₛ” such that equation 406 may be used to determine the contrast as follows:

C=ΔI/(I+Iₛ)

As the scattered radiation “Iₛ” becomes larger, the contrast becomes more limited. Thus, thick or heavy walled castings may be difficult to inspect using conventional poly-energetic x-rays and the images produced in this way may lose sensitivity to small sub-surface features of the thick walled casting structure, such as fine porosity features and inclusion features. In most cases, for radiography to be effective, the transmitted intensity through the casting structure being inspected needs to be attenuated by about ninety-seven percent (97%) or more. This means that the scattered field can be quite large.

To reduce the scattered intensity in radiography, the x-ray inspection detector is moved away from the casting structure being inspected. However, positioning the detector away from the casting structure being inspected decreases the sharpness of the x-ray image produced due to image blurring by the x-ray source spot size, unless a very small spot size is used. The advantageous embodiments recognize that if a small spot size is used as the x-ray source, the x-ray intensity is low and radiography of thick objects, such as, without limitation, titanium casting structures, is impractical.

Additionally, in conventional radiography, a bremsstrahlung x-ray source is used that is composed of a range of x-ray energies. The attenuation is a function of energy and this variation in attenuation coefficient “u” results in increased scatter from the lower energy photons and reduced image contrast “C”.

An embodiment of the present disclosure provides a brilliant x-ray inspection device that comprises a brilliant x-ray source and a detector. The brilliant x-ray source generates mono-energetic, narrow beam x-rays at an identified energy. A portion of an object is positioned within a path of the mono-energetic, narrow beam x-rays. The detector generates brilliant x-ray data. The brilliant x-ray inspection device then generates a set of brilliant x-ray images of the portion of the object that can be used to describe the object in three dimensions based on results of the x-ray scan of the object. As used herein, the term “set” refers to one or more. The features of the object are identified based on the set of brilliant x-ray images. A feature may include, without limitation, an inclusion, fine porosity, a crack, or any other feature. The features of the object may be identified in two dimensions or in three dimensions based on the set of brilliant x-ray images.

The utilization of brilliant x-rays for inspection of cast structures solves the sensitivity limitations in x-ray inspections. Currently, x-ray radiographic sensitivity in inspection is limited by the combination of the penetrating power of the x-ray at the desired x-ray energy and the scatter field intensity of the scatter radiation.

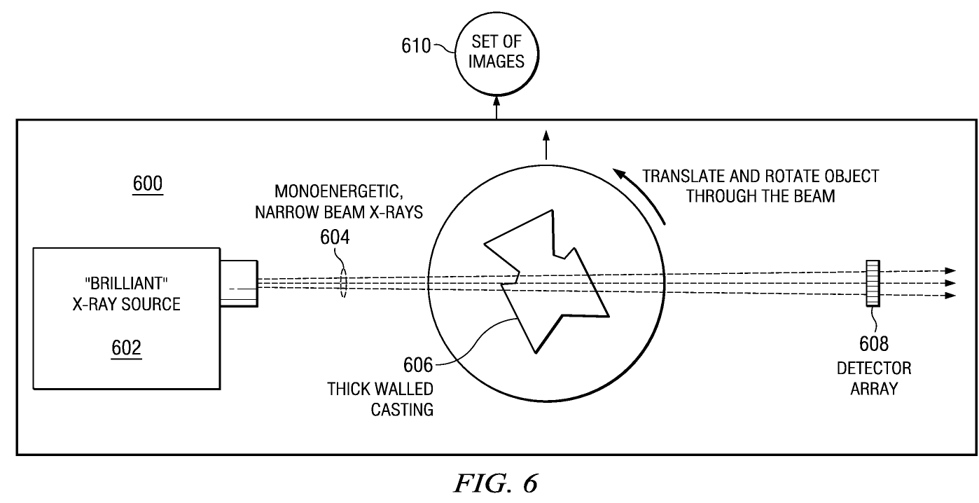

FIG. 5 is a diagram illustrating a brilliant x-ray inspection digital radiography device in accordance with an advantageous embodiment. Brilliant x-ray digital radiography inspection device 500 is a device for inspecting thick casting structures using brilliant x-ray detection in a digital radiography configuration. Brilliant x-ray digital radiography inspection device 500 may include part manipulators (not shown) for moving, translating, rotating, holding, or otherwise manipulating an object being inspected. These part manipulators may be implemented using any part manipulator devices and techniques that are currently available or that become available in the future.

Brilliant x-ray source 502 is a device that generates mono-energetic, narrow beam, x-rays 504. These mono-energetic, narrow beam x-rays may be referred to as brilliant x-rays. Brilliant x-ray source 502 may be implemented using any device for generating mono-energetic, narrow beam x-rays, such as, without limitation, a synchrotron source, high intensity laser source, or any other device capable of generating brilliant x-rays.

Brilliant x-ray source 502, in this example, generates brilliant x-rays in a short pulse using the reverse Compton effect. The reverse Compton effect increases the energy and decreases the wavelengths of photons upon interaction with matter, such as the interaction of a laser photon with a an accelerated electron creating an x-ray photon at a specific energy. In conventional x-ray radiography, a user cannot select a single energy or wavelength for the x-rays produced. Instead, in conventional x-ray radiography, a range of x-ray energies are produced by the bremsstrahlung x-ray source based on the maximum accelerating voltage. In other words, a conventional bremsstrahlung x-ray source may generate x-rays across a range of zero to four hundred kilovolts (0-400 kV) when the maximum accelerating voltage is 400 kV. Thus, there will be some of the x-rays less than one kilovolts (100 kV) while other x-rays will have an energy of one two hundred (200 kV), others still at three hundred kilovolts (300 kV) and very few at four hundred kilovolts (400 kV) but including photons at all energies in between.

However, brilliant x-ray source 502 permits a user to select a single, specific energy to form mono-energetic, narrow beam x-rays 504. A user may select a particular energy based on the type of material in thick walled casting structure 506. For example, a user may select mono-energetic narrow beam x-rays 504 at 200 kilovolts. In such a case, brilliant x-ray source 502 will generate x-rays at 200 kilovolts rather than producing x-rays across a range of energies.

In addition, with conventional, poly-energetic x-rays, there is a range of attenuation coefficients of the x-rays used that corresponds with the range of x-ray energies produced. However, with mono-energetic narrow beam x-rays 504, a single energy is selected and a single attenuation coefficient applies, therefore, an energy and a corresponding attenuation coefficient is selected based on the type of material in thick walled casting 506 to control the sensitivity of the x-ray images produced by the brilliant x-ray inspection device. In other words, a first energy may be optimal for an object composed of titanium; a second energy may be optimal for copper, and a third different energy for mono-energetic narrow beam x-ray may be optimal for an object composed of iron based on the attenuation coefficient.

It will be appreciated by one skilled in the art that the words “optimize”, “optimization” and related terms are terms of art that refer to improvements in sensitivity and inspection accuracy, and do not purport to indicate that an inspection or x-ray sensitivity is perfect, or is capable of achieving, an “optimal” or perfectly sensitive or accurate inspection state.

Thick walled casting structure 506 is an object that is produced using a casting technique, such as, without limitation, investment casting, titanium investment casting, sand casting, or any other type of casting process. Although in this example, casting structure 506 is a thick walled object; the embodiments are not limited to inspecting only thick walled objects. Brilliant x-ray digital radiography inspection device 500 may also be used to inspect thin walled casting structures.

For large, thick casting structures, such as thick walled casting 506, mono-energetic, narrow beam x-rays 504 may be used to allow thick walled casting 506 and inspection device 508 to be separated by a large distance, such that scatter does not affect the image quality or image contrast. Mono-energetic marrow beam x-rays 504 results in uniform attenuation coefficient “u” in the sample that can be controlled by the selection of the energy for the material to be tested.

Detector 508 is a device for capturing mono-energetic narrow beam x-rays 504 that have interacted with thick walled casting 506. Detector 508 moves with thick walled casting 506 as thick walled casting 506 is rotated and/or translated. In other words, detector 508 is associated with thick walled casting 506 such that detector 508 changes position as thick walled casting changes position.

Detector 508 captures brilliant x-rays that interact with thick walled casting and generates data describing thick walled casting 506 based on the x-ray energy detected by detector 508.

This data describing thick walled casting 506 may be analyzed by a data processing system associated with brilliant x-ray digital radiography inspection device 500 to form set of images 510 of thick walled casting. Set of images 510 is a set of one or more x-ray digital radiography images. The data may also be transmitted to a remote computing device via a network connection for analysis by the remote computing device. The network may include, without limitation, a local area network (LAN), a wide area network (WAN), a virtual private network (VPN), an Ethernet, Internet, or any other type of network connection.

Mono-energetic narrow beam x-rays 504 is a narrow beam that may not cover an entire object or an entire portion of the object that is being inspected. Therefore, thick walled casting 506 is rotated and translated during the x-ray process so that all of the object or all of the portion of the object that is being inspected is covered by mono-energetic narrow beam x-rays.

In this example, thick walled casting 506 is positioned in a path of mono-energetic narrow beam x-rays 504. When mono-energetic narrow beam x-rays 504 are turned on, the object is moved up and down, side to side, or otherwise rotated and translated in the path of mono-energetic narrow beam x-rays 504. When the mono-energetic narrow beam x-rays 504 is shut off, the digital radiographer associated with brilliant x-ray digital radiography inspection device 500 analyzes the data generated by detector 508 and outputs a two-dimensional image of the object.

The object may then be moved so a different side or portion of the object is within the path of mono-energetic narrow beam x-rays 504. Mono-energetic narrow beam x-rays 504 may then be turned on and the object rotated and/or moved within the path of mono-energetic narrow beam x-rays 504 to generate a second image of the object. This process of re-orienting the object and generating a new digital radiography image of the object may be repeated until the desired number of images in set of images 510 with the desired sensitivity has been generated.

Thus, greatly increased sensitivity can be achieved that is only limited by the intensity of mono-energetic narrow beam x-rays 504 and the time for data acquisition. These parameters can be optimized by energy selection and detail resolution in brilliant x-ray digital radiography inspection device 500.

In this example, the object that is scanned by brilliant x-ray source 502 is a thick walled object created by a casting process. However, the embodiment shown in FIG. 5 may be used to scan any object using brilliant x-rays to obtain a more sensitive x-ray scan of the object. The embodiments are not limited to utilization on thick walled casting structures.

In FIG. 5, an object, such as thick walled casting 506 is inspected in a radiographic mode where mono-energetic narrow beam x-rays 504 passes through and moves about the thick walled casting 506 and detector 508.

FIG. 6 is a diagram illustrating a brilliant x-ray inspection computed tomography device in accordance with an advantageous embodiment. Brilliant x-ray computed tomography inspection device 600 is a device for inspecting thick casting structures using brilliant x-ray detection in a computed tomography configuration. Brilliant x-ray computed tomography inspection device 600 may include part manipulators (not shown) for moving, translating, rotating, holding, or otherwise manipulating an object being inspected. These part manipulators may be implemented using any part manipulator devices and techniques that are currently available or that become available in the future.

Brilliant x-ray source 602 is a device for generating mono-energetic, narrow beam x-rays 604, such as brilliant x-ray source 502 in FIG. 5. Thick walled casting 606 is an object that is produced using a casting technique, such as, without limitation, investment casting, titanium investment casting, sand casting, or any other casting process.

Mono-energetic narrow beam x-rays 604 is a narrow beam that may not cover an entire object or an entire portion of the object that is being inspected. Therefore, thick walled casting 606 is rotated and translated during the x-ray process so that all of the object or all of the portion of the object that is being inspected is covered by mono-energetic narrow beam x-rays.

Detector array 608 is an array of one or more detectors for detecting brilliant x-rays that have interacted with thick walled casting 606 or any part of thick walled casting 606. In this example, detector array 608 is fixed in place. When an object being x-rayed, such as thick walled casting 606, is being rotated and/or translated through mono-energetic narrow beam x-rays 604, detector array 608 remains stationary.

Detector array 608 generates data describing the three dimensional features of thick walled casting 606 based on the x-ray energy detected by detector 608. This data may be analyzed by a data processing system associated with brilliant x-ray computed tomography inspection device 600 to form set of images 610 of thick walled casting. Set of images 610 is a set of one or more images. Set of images 610 may include, without limitation, three-dimensional (3-D) images or cross-sections of thick walled casting 606.

The data generated by detector array 608 may also be transmitted to a remote computing device via a network connection for analysis by the remote computing device. The network may include, without limitation, a local area network (LAN), a wide area network (WAN), a virtual private network (VPN), an Ethernet, Internet, or any other type of network connection.

Brilliant x-ray computed tomography inspection device 600 uses x-ray computed tomography to analyze the data generated by small detector array. X-ray computed tomography is a non-destructive process that digitally reconstructs 3-D images or cross-sections of thick walled casting 606 using compiled information from a series of x-ray projections. An object, such as thick walled casting 606, is positioned in front of mono-energetic narrow beam x-rays 604. During the x-ray process, the object is translated and/or rotated through mono-energetic narrow beam x-rays 604 so that an entire area of the object is covered or painted by the brilliant x-rays. The brilliant x-ray beam is then disengaged and the object may then be repositioned so that a different area or face of the object will be within the path of the brilliant x-ray beam. After the brilliant x-ray beam is turned back on, brilliant x-ray computed tomography inspection device 600 again translates and/or rotates the object through the x-ray beam so that the narrow brilliant x-ray beam covers or paints the entire surface area, or a sufficient area for suitable reconstruction of detail, of the portion of the object that is being x-rayed.

Brilliant x-ray computed tomography inspection device 600 creates a three dimensional volumetric reconstruction of the object. Brilliant x-ray computed tomography inspection device 600 can create an image of any plane through the object. In other words, Brilliant x-ray computed tomography inspection device 600 can create cross-section views of images of slices of the object to provide images of the internal features of the object. Users may be able to view the results of x-ray inspection only a few minutes after the series of x-ray projections are complete.

In FIG. 6, an object, such as thick walled casting 606 is inspected in a computed tomography mode where thick walled casting 606 is translated and rotated in the beam of mono-energetic narrow beam x-rays 604 for computed tomography inspection. In this example, the object that is scanned by brilliant x-ray source 602 is a thick walled object created by a casting process. However, the embodiment shown in FIG. 6 may be used to scan any object using brilliant x-rays to obtain a more sensitive x-ray scan of the object. The embodiments are not limited to utilization on thick walled casting structures.

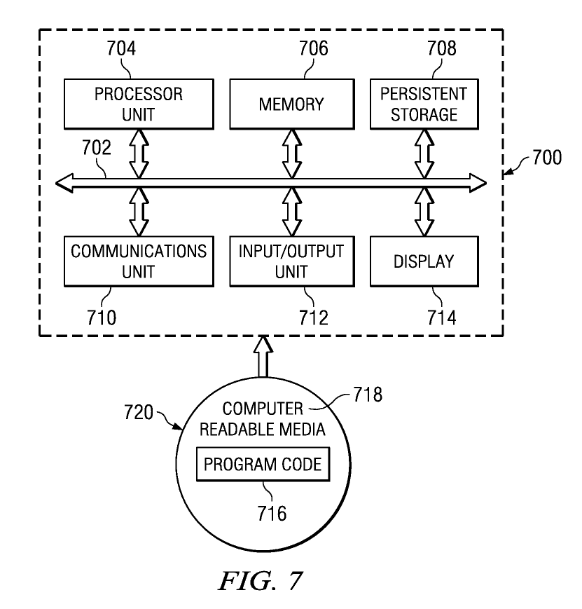

With reference now to FIG. 7, a diagram illustrating a data processing system is shown in which advantageous embodiments may be implemented. Data processing system 700 is an example of a computer, such as a server, a client, or any computing device in which computer usable program code or instructions implementing the processes may be located for the illustrative embodiments. Data processing system 700 may be implemented as a desktop computer, a personal computer, a laptop computer, a personal digital assistant (PDA), a smart phone, or any other type of computing device.

Data processing system 700 may be incorporated within a brilliant x-ray inspection device or receive image data from a brilliant x-ray inspection device, such as brilliant x-ray digital radiography inspection device 500 in FIG. 5 or brilliant x-ray computed tomography inspection device 600 in FIG. 6. Data processing system 700 may receive data from a brilliant x-ray inspection device through a wired connection, through a wireless network connection, or from a removable data storage device, such as a flash memory or a memory stick that is plugged into a port associated with data processing system 700.

In this illustrative example, data processing system 700 includes communications fabric 702, which provides communications between processor unit 704, memory 706, persistent storage 708, communications unit 710, input/output (I/O) unit 712, and display 714.

Processor unit 704 serves to execute instructions for software that may be loaded into memory 706. Processor unit 704 may be a set of one or more processors or may be a multi-processor core, depending on the particular implementation. Further, processor unit 704 may be implemented using one or more heterogeneous processor systems in which a main processor is present with secondary processors on a single chip. As another illustrative example, processor unit 704 may be a symmetric multi-processor system containing multiple processors of the same type.

Memory 706 and persistent storage 708 are examples of storage devices. A storage device is any piece of hardware that is capable of storing information either on a temporary basis and/or a permanent basis. Memory 706, in these examples, may be, for example, a random access memory or any other suitable volatile or non-volatile storage device. Persistent storage 708 may take various forms depending on the particular implementation. For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these examples, provides for communications with other data processing systems or devices. In these examples, communications unit 710 is a network interface card. Communications unit 710 may provide communications through the use of either or both physical and wireless communications links.

Input/output unit 712 allows for input and output of data with other devices that may be connected to data processing system 700. For example, input/output unit 712 may provide a connection for user input through a keyboard and mouse. Further, input/output unit 712 may send output to a printer. Display 714 provides a mechanism to display information to a user.

Instructions for the operating system and applications or programs are located on persistent storage 708. These instructions may be loaded into memory 706 for execution by processor unit 704. The processes of the different embodiments may be performed by processor unit 704 using computer implemented instructions, which may be located in a memory, such as memory 706. These instructions are referred to as program code, computer usable program code, or computer readable program code that may be read and executed by a processor in processor unit 704. The program code in the different embodiments may be embodied on different physical or tangible computer readable media, such as memory 706 or persistent storage 708.

Program code 716 is located in a functional form on computer readable media 718 that is selectively removable and may be loaded onto or transferred to data processing system 700 for execution by processor unit 704. Program code 716 and computer readable media 718 form computer program product 720 in these examples. In one example, computer readable media 718 may be in a tangible form, such as, for example, an optical or magnetic disc that is inserted or placed into a drive or other device that is part of persistent storage 708 for transfer onto a storage device, such as a hard drive that is part of persistent storage 708. In a tangible form, computer readable media 718 also may take the form of a persistent storage, such as a hard drive, a thumb drive, or a flash memory that is connected to data processing system 700. The tangible form of computer readable media 718 is also referred to as computer recordable storage media. In some instances, computer recordable media 718 may not be removable.

Alternatively, program code 716 may be transferred to data processing system 700 from computer readable media 718 through a communications link to communications unit 710 and/or through a connection to input/output unit 712. The communications link and/or the connection may be physical or wireless in the illustrative examples. The computer readable media also may take the form of non-tangible media, such as communications links or wireless transmissions containing the program code.

The different components illustrated for data processing system 700 are not meant to provide architectural limitations to the manner in which different embodiments may be implemented. The different illustrative embodiments may be implemented in a data processing system including components in addition to or in place of those illustrated for data processing system 700. Other components shown in FIG. 7 can be varied from the illustrative examples shown.

As one example, a storage device in data processing system 700 is any hardware apparatus that may store data. Memory 706, persistent storage 708, and computer readable media 718 are examples of storage devices in a tangible form.

In another example, a bus system may be used to implement communications fabric 702 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 706 or a cache such as found in an interface and memory controller hub that may be present in communications fabric 702.

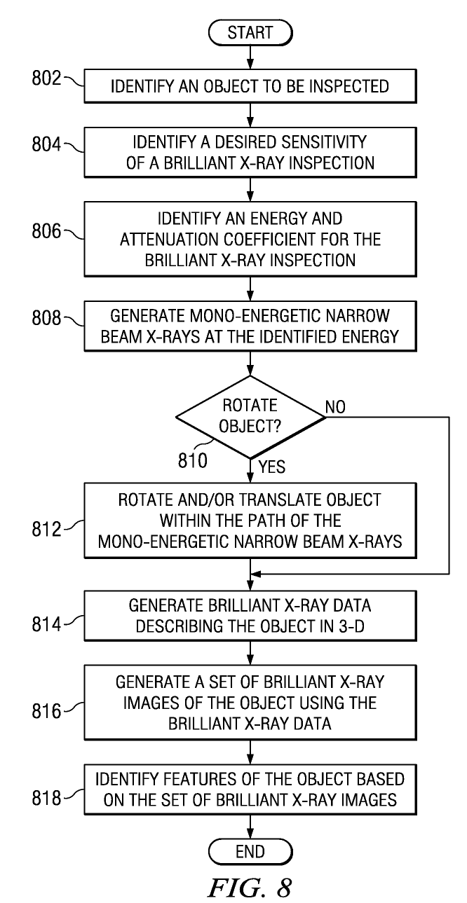

FIG. 8 is a flowchart illustrating a process for inspecting a casting structure using a brilliant x-ray inspection device in accordance with an advantageous embodiment. The process in FIG. 8 may be implemented by a brilliant x-ray inspection device, such as brilliant x-ray digital radiographic inspection device 500 in FIG. 5 or brilliant x-ray computed tomography inspection device 600 in FIG. 6.

The process begins by identifying an object to be inspected (operation 802). The object may be a casting structure that was produced during a casting process. A desired sensitivity of a brilliant x-ray inspection is identified (operation 804). This operation may be performed automatically by the brilliant x-ray inspection device based on default settings, pre-selected preferences, or by checking a lookup table based on the materials from which the object was made. For example, there may be default sensitivity for any object that is made of titanium. In another embodiment, a user may manually enter a desired sensitivity level.

An energy and attenuation coefficient for the brilliant x-ray inspection is identified (operation 806). Again, the energy and attenuation coefficient may be automatically identified based on default settings, pre-selected preferences, checking a look-up table based on the materials from which the object is composed. Also, the attenuation coefficient and/or the energy may be manually entered by a user. In this example, the energy is a selected energy in kilovolts.

Mono-energetic, narrow beam x-rays are generated at the identified energy (operation 808). In other words, if the identified energy is 200 kV, then the mono-energetic, narrow beam x-rays will have an energy of 200 kV. A determination is made as to whether to rotate the object within the brilliant x-ray beam (operation 810). If the object is to be rotated, the object is rotated and/or translated within the path of the mono-energetic, narrow beam x-rays (operation 812).

The brilliant x-ray inspection device then generates brilliant x-ray data that describes the object in three dimensions (operation 814). The brilliant x-ray inspection device generates a set of brilliant x-ray images of the object using the brilliant x-ray data (operation 816). The set of images may include a single image or two or more images. The images may be two-dimensional or three-dimensional images. Features of the object are then identified based on the set of brilliant x-ray images (operation 818) with the process terminating thereafter. The features of the object may include, without limitation, inclusions, cracks, fine porosity, or any other feature. The features may be identified by a human user manually viewing the images in set of images.

In one advantageous embodiment, a brilliant x-ray inspection device comprises a brilliant x-ray source and a inspection device. The brilliant x-ray source generates mono-energetic, narrow beam x-rays at an identified energy. A portion of an object is positioned within a path of the mono-energetic, narrow beam x-rays. The detector generates brilliant x-ray data describing the object in three dimensions based on results of the x-ray scan of the object. The brilliant x-ray inspection device then generates a set of brilliant x-ray images of the portion of the object, by the brilliant x-ray inspection device, wherein features of the object are identified based on the set of brilliant x-ray images.

Brilliant x-ray inspection may be used to increase the sensitivity of inspections of thick sections of titanium castings, and thus, permit sufficient accuracy of inspections to permit utilization of castings of greater thickness in aerospace applications. For example, the brilliant x-ray inspection may achieve a sensitivity of 0.0001 or greater when inspecting thick titanium cast structures that are greater than two inches thick. In addition, brilliant x-ray inspections may enable the use of titanium casting with cost savings approaching an order of magnitude in buy-to-fly costs relative to titanium parts manufactured using forgings and built up structures. This enables the use of titanium casting with significant cost savings and allows substitution of cast titanium unitized structures for assembled parts.

The brilliant x-ray digital radiography inspection device and the brilliant x-ray computed tomography inspection device improves sensitivity to fine detail in nondestructive inspections. In the case of casting structures, the brilliant x-ray inspection devices enables improved accuracy of detection of fine porosity, inclusions, and other sub-surface inconsistencies in thick titanium structures that may be difficult to detect using conventional, poly-energetic x-ray detection techniques. The brilliant x-ray inspection device also allows the utilization of advanced alloys and materials in cast structures with subsequent cost savings.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A brilliant x-ray inspection device comprising:
a brilliant x-ray source, wherein the brilliant x-ray source generates mono-energetic, narrow beam x-rays at an identified energy, and wherein a portion of an object is positioned within a path of the mono-energetic, narrow beam x-ray; and
a detector, wherein the detector generates brilliant x-ray data, wherein the brilliant x-ray inspection device generates a set of brilliant x-ray images over a region of the object, and wherein the features of the object are identified based on the set of brilliant x-ray images.

2. The brilliant x-ray inspection device of claim 1 wherein the detector is a digital radiography detector, wherein the brilliant x-ray inspection device generates two-dimensional digital radiographic images of the object based on the brilliant x-ray data.

3. The brilliant x-ray inspection device of claim 1 wherein the detector is a computed tomography detector, and wherein the brilliant x-ray inspection device generates three dimensional computer tomography images of the object based on the brilliant x-ray data.

4. The brilliant x-ray inspection device of claim 1 further comprising:
a set of object manipulators, wherein the set of object manipulators rotate and translate the object within the path of the mono-energetic, narrow beam x-rays.

5. The brilliant x-ray inspection device of claim 1 wherein the object is a thick walled titanium casting structure.

6. The brilliant x-ray inspection device of claim 1 further comprising:
an input/output unit, wherein the input/output unit receives a selection of an energy to form the identified energy.

7. The brilliant x-ray inspection device of claim 1 further comprising:
an input/output unit, wherein the input/output unit receives a selection of a sensitivity level, wherein the brilliant x-ray inspection device identifies an energy corresponding to the selected sensitivity level to form the identified energy.

8. A method for inspecting casting structures, the method comprising:
identifying an energy and attenuation coefficient for a brilliant x-ray inspection of an object;
generating mono-energetic, narrow beam x-rays at the identified energy, by a brilliant x-ray inspection device, to form an x-ray scan of the object, wherein a portion of the object is positioned within a path of the mono-energetic, narrow beam x-rays;
generating brilliant x-ray data describing the object in three dimensions based on results of the x-ray scan of the object; and
generating a set of brilliant x-ray images of the portion of the object, by the brilliant x-ray inspection device, wherein features of the object are identified based on the set of brilliant x-ray images.

9. The method of claim 8 further comprising:
changing an orientation of the object to form a different position of the object, wherein a different portion of the object is within the path of the mono-energetic, narrow beam x-rays in the different position of the object; and
generating a second set of images, wherein generating multiple set of images of the object at a plurality of different orientations increases a sensitivity of detection of features of the object.

10. The method of claim 8 wherein the object is a thick walled titanium casting structure.

11. The method of claim 8 wherein the brilliant x-ray inspection device is a brilliant x-ray digital radiography inspection device, and wherein the set of images comprises a two-dimensional digital radiography image of the portion of the object.

12. The method of claim 8 wherein the brilliant x-ray inspection device is a brilliant x-ray computed tomography inspection device, and wherein the set of images comprises at least one computed tomography three-dimensional image of the portion of the object.

13. The method of claim 8 further comprising:
rotating and translating the object within the mono-energetic, narrow beam x-rays.

14. An apparatus comprising:
a bus system;
a communications system coupled to the bus system;
a memory connected to the bus system, wherein the memory includes computer usable program code; and
a processing unit coupled to the bus system, wherein the processing unit executes the computer usable program code to receive a result of a brilliant x-ray scan of an object, wherein a portion of the object is scanned by mono-energetic, narrow beam x-rays at an identified energy; generate brilliant x-ray data describing the object in three dimensions based on results of the x-ray scan of the object; and generate a set of brilliant x-ray images of the portion of the object, by the brilliant x-ray inspection device, wherein features of the object are identified based on the set of brilliant x-ray images.

15. The apparatus of claim 14 wherein the processor unit further executes the computer usable program code to automatically change an orientation of the object to form a different position of the object, wherein a different portion of the object is within the path of the mono-energetic, narrow beam x-rays in the different position of the object; and generate a second set of images, wherein generating multiple set of images of the object at a plurality of different orientations increases a sensitivity of detection of features of the object.

16. The apparatus of claim 14 wherein the object is a thick walled titanium casting structure.

17. The apparatus of claim 14 wherein the set of images comprises a two-dimensional digital radiography image of the portion of the object.

18. The apparatus of claim 14 wherein the set of images comprises at least one computed tomography three-dimensional image of the portion of the object.

19. The apparatus of claim 14 wherein the processor unit further executes the computer usable program code to identify an energy for a brilliant x-ray inspection of an object based on a desired sensitivity level to form the identified energy.

20. The apparatus of claim 14 further comprising:
a brilliant x-ray detector, wherein the brilliant x-ray detector generates the result of the brilliant x-ray scan of the object.
